(19) United States
(12) Patent Application Publication
(10) Pub. No.: US 2025/0245191 A1
(43) Pub. Date: Jul. 31, 2025

(54) AI-BASED FILE TRANSFORMATIONS

(71) Applicant: TEACHERS INSURANCE AND ANNUITY ASSOCIATION OF AMERICA, New York, NY (US)

(72) Inventors: Daniel Ray Hursh, Dayton, OH (US); Alexis Salvatore Pecoraro, Huntersville, NC (US); Sheppard David Narkier, Charlotte, NC (US)

(21) Appl. No.: 18/424,538

(22) Filed: Jan. 26, 2024

(51) Int. Cl. G06F 16/11; G06N 20/00

(52) U.S. Cl. CPC G06F 16/116; G06N 20/00

(57) ABSTRACT

System, method, and apparatus for transforming computer files are provided. The method, implemented by one or more processors, comprises: inputting a source file and a source file specification, the source file including one or more source data items, the source file specification defining formats of the one or more source data items; generating, using a generative AI model based on the source data and the source file specification, a source file model including one or more source nodes, each of one or more source nodes associated with a respective data item of the one or more source data items; generating, using the generative AI model, a transform map mapping the one or more source nodes to one more target nodes of a target file model; invoking, a semantic model-based transformation service to generate an output file; and invoking a comparison module to compare the output file to an output sample.

### FIELD OF TECHNOLOGY

The present disclosure relates to artificial intelligence (AI) based model builder systems, methods, and computer readable medium, and more particularly, to artificial intelligence (AI) based model builder systems, methods, and computer readable medium storing computing instructions for automatically transforming computer files, messages, or other digital media as described herein.

### BACKGROUND

A computing platform may exchange data with its existing and/or potential computing clients, including various clients implementing different operating systems, protocols, file types and the like. For example, client devices can send and receive information, in various formats, for performing computing activities such as client enrollment, onboarding, reporting, as well as various operations related to the computing platform. The layouts, field nomenclature, field formatting and/or encoding rules used in files of a given client may be different from the layouts, field nomenclature, field formatting and/or encoding rules used in files of another client computing device. Therefore, client devices of different entities may need to transform data in files to perform certain transactions.

Conventional techniques may require engineers to manually transform files or manually develop programs to transform files. This process can be cumbersome and inefficient, especially when there is an enormous amount data in the files. Conventional techniques may have other drawbacks. Therefore, techniques for efficiently and accurately transforming files are in need.

### SUMMARY

One exemplary embodiment of the present disclosure may be artificial intelligence (AI) based model builder system configured to automatically transform computer files. The system may include: one or more processors; and a training base comprising a memory configured to store data formats, sample data, and data specifications defining one or more respective file types; a generative AI model; a model and map builder engine comprising computing instructions configured to access the AI model and the training base. The computing instructions of the model and map builder engine, when executed by the one or more processors, may cause the one or more processors to: input a source file and a source file specification, corresponding to a source file type selected from the training base, the source file including one or more source data items, the source file specification defining formats of the one or more source data items; generate, using the generative AI model based on the source file and the source file specification, a source file model comprising a source-based graph representation including one or more source nodes, each of one or more source nodes associated with a respective data item of the one or more source data items; generate, using the generative AI model, a transform map mapping the one or more source nodes to one more target nodes of a target-based graph of a target file model corresponding to a target file type; invoke a semantic model-based transformation service to generate an output file by applying the transform map to the one or more nodes of the source file model; and invoke a comparison module to compare the output file to an output sample, the output sample describing expected formats of the output file.

One exemplary embodiment of the present disclosure may be a computer-implemented artificial intelligence (AI) based model builder method for automatically transforming computer files. The computer-implemented method may comprise: inputting, by one or more processors, a source file and a source file specification, corresponding to a source file type selected from the training base, the source file including one or more source data items, the source file specification defining formats of the one or more source data items; generating, by the one or more processors using a generative AI model based on the source data and the source file specification, a source file model comprising a source-based graph representation including one or more source nodes, each of one or more source nodes associated with a respective data item of the one or more source data items; generating, by the one or more processors using the generative AI model, a transform map mapping the one or more source nodes to one more target nodes of a target-based graph of a target file model corresponding to a target file type; invoking, by the one or more processors, a semantic model-based transformation service to generate an output file by applying the transform map to the one or more nodes of the source file model; and invoking, by the one or more processors, a comparison module to compare the output file to an output sample, the output sample describing expected formats of the output file.

Yet another exemplary embodiment of the present disclosure is a computer readable storage medium storing computing instructions for automatically transforming computer files with artificial intelligence (AI). The computing instructions, when executed by one or more processors, may cause the one or more processors to: input a source file and a source file specification, corresponding to a source file type selected from the training base, the source file including one or more source data items, the source file specification defining formats of the one or more source data items; generate, using a generative AI model based on the source data and the source file specification, a source file model comprising a source-based graph representation including one or more source nodes, each of one or more source nodes associated with a respective data item of the one or more source data items; generate, using the generative AI model, a transform map mapping the one or more source nodes to one more target nodes of a target-based graph of a target file model corresponding to a target file type; invoke a semantic model-based transformation service to generate an output file by applying the transform map to the one or more nodes of the source file model; and invoke a comparison module to compare the output file to an output sample, the output sample describing expected formats of the output file.

In accordance with the above, and with the disclosure herein, the present disclosure includes improvements in computer functionality and/or improvements to other technologies at least because the claims recite, e.g., a model and map builder engine configured to generate a source file model comprising a source-based graph representation including one or more source nodes. The source file model comprising a source-based graph representation can then be used, by the generative AI model, to generate and compare output file types in order to test for compatibility between different formats/types, without the need for multiple iterations and testing resources otherwise needed for conventional data interoperability. In various aspects, the source file model comprising a source-based graph representation including one or more source nodes is used to generate a transform map across one or more nodes of source file model that have been created for a plurality of file types and/or formats. The generative AI model maps the various nodes, each of which may refer to file names, file formats, file protocols, and/or other file base attributes of different file types. The nodes may be tested, among file types, to check file conversion and compatibility before implementation of any data interoperability. In this way, generation of the transform map, as used to check and test file types and/or formats prevents errors before they occur (e.g., errors that can occur from use of incompatible file types and/or formats). Such reduction of error reduces impact, error states, and downtime of the computing system as a whole. Still further, generation and use of the transform map prevents the need for testing, over multiple compute cycles, compatibility of files and formats, which results in fewer computational resources, such as compute cycles used during testing and/or memory used to store various versions of file conversion software during development and testing of the conversion software itself. Thus, the present disclosure describes improvements in the functioning of the computer itself or “any other technology or technical field” because the transform map, as generated by the model and map builder engine, allow for efficient data interoperability by discovering, by implementing AI, file metadata, file rules, file types, and file formats, and uses such information to map two otherwise different file types and/or formats together. This improves over the prior art at least because system or platforms, which would otherwise be required to implement multiple iterations, including various versions and test of software, which would require increased memory storage and/or execution cycles compared to the systems and methods described herein.

The present disclosure includes specific features other than what is well-understood, routine, conventional activity in the field, and/or otherwise adds unconventional steps that confine the disclosure to a particular useful application, e.g., artificial intelligence (AI) based model builder systems and methods for automatically transforming computer files.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the system and methods disclosed therein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 is a block diagram of an example computing system in which techniques for AI-based file transformations can be implemented, according to some embodiments.

FIG. 2A depicts a content of an example source file to be used by techniques disclosed herein, according to some embodiments.

FIG. 2B depicts a content of an example source file specification to be used by techniques disclosed herein, according to some embodiments.

FIG. 2C depicts an example file model generated by techniques disclosed herein, according to some embodiments.

FIG. 3 depicts an example transform map generated by techniques disclosed herein, according to some embodiments.

FIG. 4 shows an example source file and an example output file generated by transforming the example source file, according to some embodiments.

FIG. 5 is a block diagram of an example process in which techniques for AI-based file transformations can be implemented, according to some embodiments.

FIG. 6 depicts a structure of an example AI model to be used by techniques disclosed herein, according to some embodiments.

FIG. 7 depicts an example process of training an example AI model to be used by techniques disclosed herein, according to some embodiments.

FIG. 8 is an example sequence diagram that illustrates a method for AI-based file transformations, according to some embodiments.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The disclosure provides a system, method, and apparatus for file transformations using one or more AI models. As used herein, the term “computer file” may refer to any file that can be processed by a computer, including digital files, digital media, and digital messages in any appropriate format.

In one aspect, using transform maps may allow the system to first perceive a general data structure of a source file and then transform the source file in a more organized way, comparing to file transformations not based on models or transform maps. The system may use a generative AI to generate source file models and transform maps for file transformation purposes. Instead of requiring a software developer to create source file models and transform maps, the system disclosed herein may use a generative AI model to generate the source file models and transform maps in a short period of time. Therefore, the techniques disclosed herein may save significant time for data transformations.

In one aspect, the system disclosed herein may use an AI model for comparison to determine whether an output file is as expected. As generative AI may sometimes generate unreliable output (e.g., an AI hallucination), using another AI model (either a discriminative AI model or another generative AI model) to determine whether the output file meets expectations may increase the reliability of the system for AI-based file transformations. Such testing reduces error between file type conversions and/or data interoperability.

In one aspect, the system may continuously input the source file models and transform maps associated with successful transformations to a training base. The system may continuously train the one or more AI models using the newly-added source file models and transform maps. Therefore, in such aspects, the system may be continuously updated and trained with such file models and models. In this way, the system can learn, through artificial intelligence, from past successful experiences and automatically improve its ability to interoperate among file types. The system may also meet users' changing needs better through its self-updates.

Other advantages and benefits will be clear in view of the detailed description below.

### Example Computing System

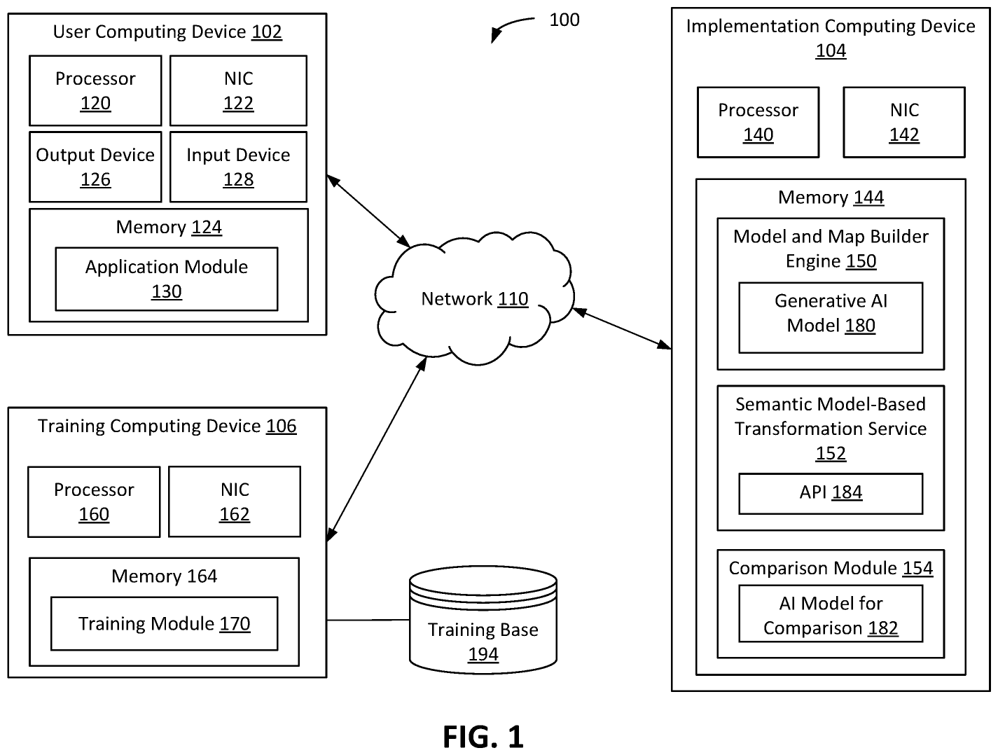

FIG. 1 illustrates an example system 100 in which one or more techniques for AI-based may be implemented. The example system 100 may include a user computing device 102, an implementing computing device 104, a training computing device 106, and a network 110. The user computing device 102, the implementing computing device 104, and the training computing device 106 may be remote from each other and are communicatively connected via the network 110.

The network 110 may be a single communication network (e.g., the Internet), and in some embodiments also includes one or more additional networks. As just one example, the network 110 may include a cellular network, the Internet, and a server-side local area network (LAN).

The user computing device 102 is generally configured to receive input from a user and present output to the user. While FIG. 1 shows only a single user computing device 102, it should be understood that the system 100 may include any suitable number of similar user computing devices operating according to the principles disclosed herein. The user computing device 102 may be or include any stationary, mobile, or portable computing device with wired and/or wireless communication capability (e.g., a smartphone, a tablet computer, a laptop computer, a desktop computer, a smart wearable device, etc.). In the example embodiment of FIG. 1, the user computing device 102 includes a processor 120, a network interface 122, and memory 124. The user computing device 102 further includes or is associated with an output device 126 and an input device 128.

The processor 120 may be a single processor (e.g., a central processing unit (CPU)), or may include a set of processors (e.g., multiple CPUs, or one or more CPUs and one or more graphics processing units (GPUs)). Although the output device 126 is depicted as part of the user computing device 102, it should be understood that the output device 126 may be external to the user computing device 102 and communicatively connected to the user computing device 102 with wires and/or the network 110.

The output device 126 may include hardware, firmware, and/or software configured to enable a user to view visual outputs of the user computing device 102, and may use any suitable display technology (e.g., LED, OLED, LCD, etc.). Moreover, in some embodiments where the user computing device 102 is a wearable device, the output device 126 may be a transparent viewing component (e.g., lenses of VR glasses) with integrated electronic components. For example, the output device 126 may include micro-LED or OLED electronics embedded in lenses of smart glasses.

The input device 128 is capable of receiving inputs from the ambient environment and/or a user, such as a keyboard, a mouse, buttons, keys, a microphone, etc. Further, the input device 128 may be integrated with the output device 126 as a touch screen having both input and output capabilities.

The network interface controller (NIC) 122 may include hardware, firmware, and/or software configured to enable the user computing device 102 to exchange electronic data with the implementation computing device 104 via the network 110. For example, the NIC 122 may include a cellular communication transceiver, a Wi-Fi transceiver, and/or transceivers for one or more other wired and/or wireless communication technologies.

The memory 124 may include one or more computer-readable, non-transitory storage units or devices, which may include persistent (e.g., hard disk) and/or non-persistent memory components. The memory 124 may store instructions that are executable by the processor 120 to perform various operations, including the instructions of various software applications and the data generated and/or used by such applications.

In the example embodiment of FIG. 1, the memory 124 may store at least an application module 130. The application module 130 may include instructions for collecting source files and source file specifications from the user and presenting output files to the user.

In some embodiments, the application module 130 may be omitted. In some embodiments, the user computing device 102 may be omitted. That is, the implementation computing device 104 may receive documents from the user and present documents to the user directly.

The implementation computing device 104 is generally configured to generate output files based on source file and source file specifications. The implementation computing device 104 may include a processor 140, a network interface controller (NIC) 142, and memory 144.

The processor 140 may be a single processor or may include two or more processors. The implementation computing device 104 may include one or more servers, for example, which may reside at a single location or multiple locations. In some embodiments, the implementation computing device 104 may be a cloud computing platform.

The NIC 142 may include hardware, firmware, and/or software configured to enable the implementation computing device 104 to exchange electronic data with the user computing device 102 and other, similar to user devices via the network 110. For example, the NIC 142 may include a wired or wireless router and a modem.

The memory 144 may be a computer-readable, non-transitory storage unit or device, or collection of units/devices, which may include persistent and/or non-persistent memory components. The memory 144 may store the instructions of model and map builder engine 150, a semantic model-based transformation service 152, and a comparison module 154, each of which may be executed by the processor 140.

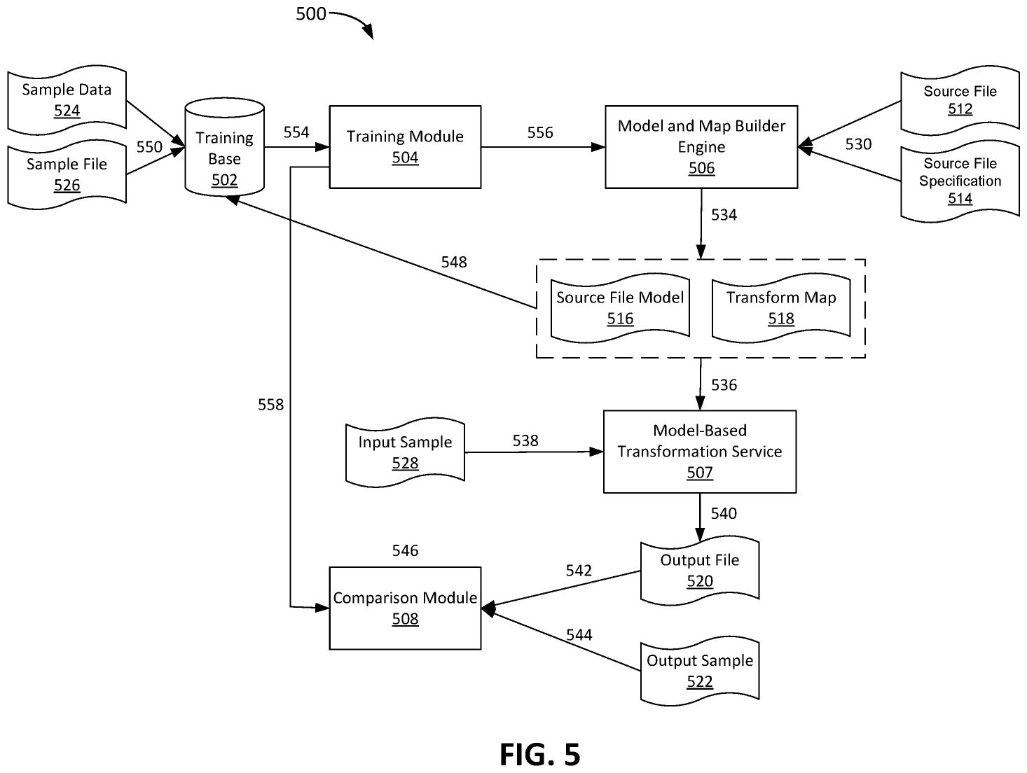

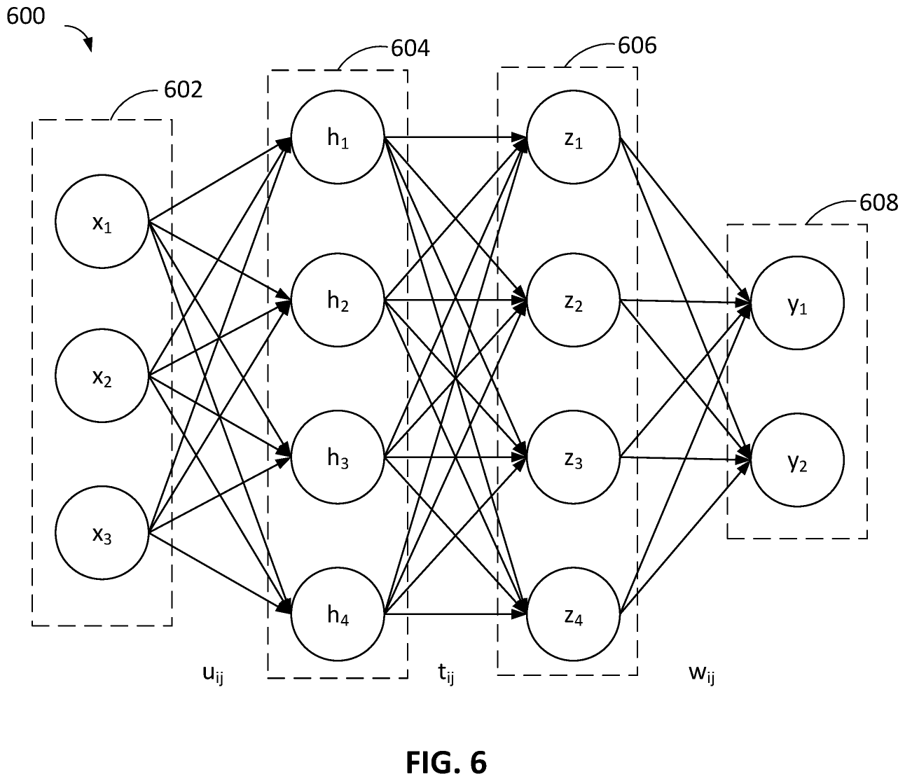

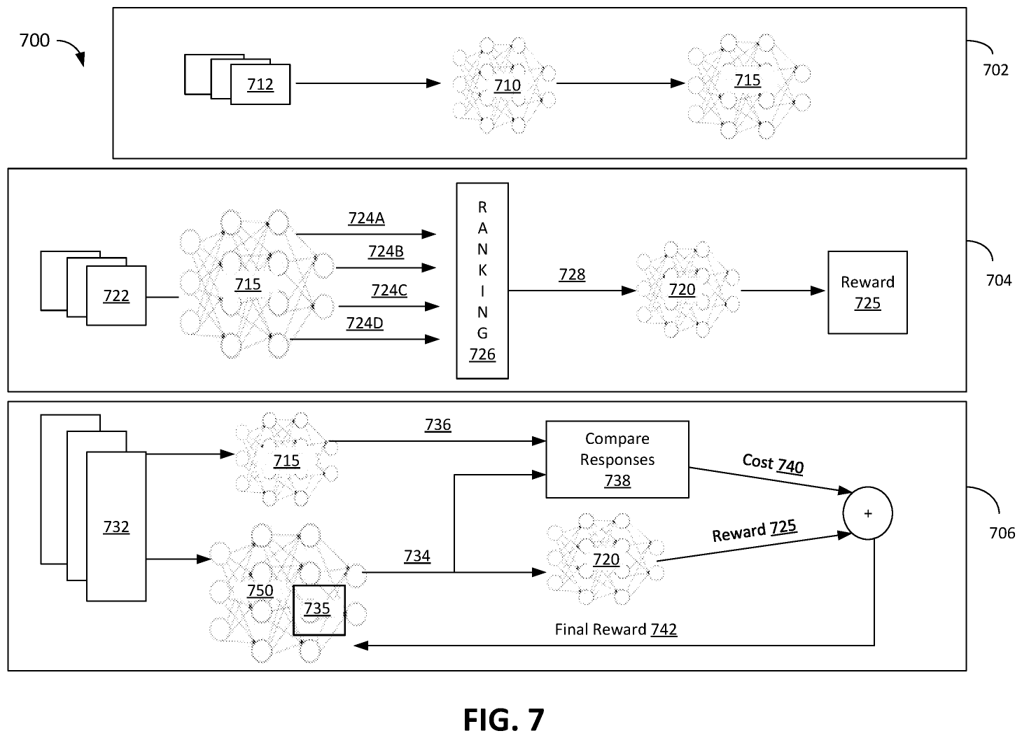

The model and map builder engine 150 may include instructions for generating source file models and transform maps based on source files and source file specifications. The model and map builder engine 150 may include instructions for implementing a generative AI model 180. The model and map builder engine 150 may include instructions for accessing and using the generative AI model 180 to generate source file models and transform maps, as will be described below with respect to FIG. 5 at the building stage. The model and map builder engine 150 may include instructions for accessing a training base 194 (described below) to retrieve data from and input data to the training base 194. Such instructions may include SQL or NoSQL code for accessing a relational database and/or a NoSQL (e.g., Mongo DB) database. Details of training the generative AI model 180 will be described below with respect to FIGS. 6 and 7.

The semantic model-based transformation service 152 may include instructions for generating source file models and transform maps based on source files and source file specifications. In various aspects, the semantic model may comprise a semantic data model (SDM). Generally, SDMs are configured to operate on or across various datasets and interoperate among the relationships between these interconnected sets. SDMs allow utilize of data more efficiently. In various aspects, SDMs describe objects and structures of datasets, allowing for efficient access and navigation of complex mechanics of data as described. In various aspects, an SDM can be implemented as a conceptual model defined on a higher level or layer for capturing a database's semantic description, structure, and/or form. The SDM may comprise a software layer for accessing a database, where the database is a data repository designed for access and management of data that is collected. The semantic model-based transformation service 152 may include an application programming interface (API) 184. The implementation computing device 104 may input the source file model and transform map via the APIs 184, and generate output files thereby, as will be described below with respect to FIG. 5 at the transformation stage.

The comparison module 154 may include instructions for determining whether output files match respective output samples. The comparison module 154 may include instructions for implementing an AI model 182 for performing such comparison. The AI model 182 may be a generative AI model or a discriminative AI model. The comparison module 154 may use the AI model 182 to determine whether output files match respective output samples, as will be described below with respect to FIG. 5 at the testing stage. Details of training the AI model 182 will be described below with respect to FIGS. 6 and 7.

The training computing device 106 may be generally configured to train the one or more AI models described above. The training computing device 106 may include a processor 160, a network interface controller (NIC) 162, and memory 164. The processor 160 may be configured in a similar manner as described above with respect to the processor 140. The NIC 162 may be configured in a similar manner as described above with respect to the NIC 142. In some embodiments, the training computing device 106 may include or communicatively connected to a training data base 194.

The memory 164 is a computer-readable, non-transitory storage unit or device, or collection of units/devices, that may include persistent and/or non-persistent memory components. The memory 164 may store the instructions of a training module 170.

The training module 170 may include instructions for training the one or more AI models to be used by the implementation computing device 104. The training computing device 106 may train and/or continuously train the AI models using the training data set in the training base 194. The details for training and/or continuously train an AI model will be described in detail below with respect to FIGS. 6 and 7. After the AI models are trained, the implementation computing device 104 may retrieve the trained AI models from the training computing device 106 and use them when needed.

In some embodiments, the training computing device 106 may be omitted. In such embodiments, the implementation computing device 104 may include the training module 170 to train the AI models thereby.

### Example File Model and Transform Map

### Example File Model

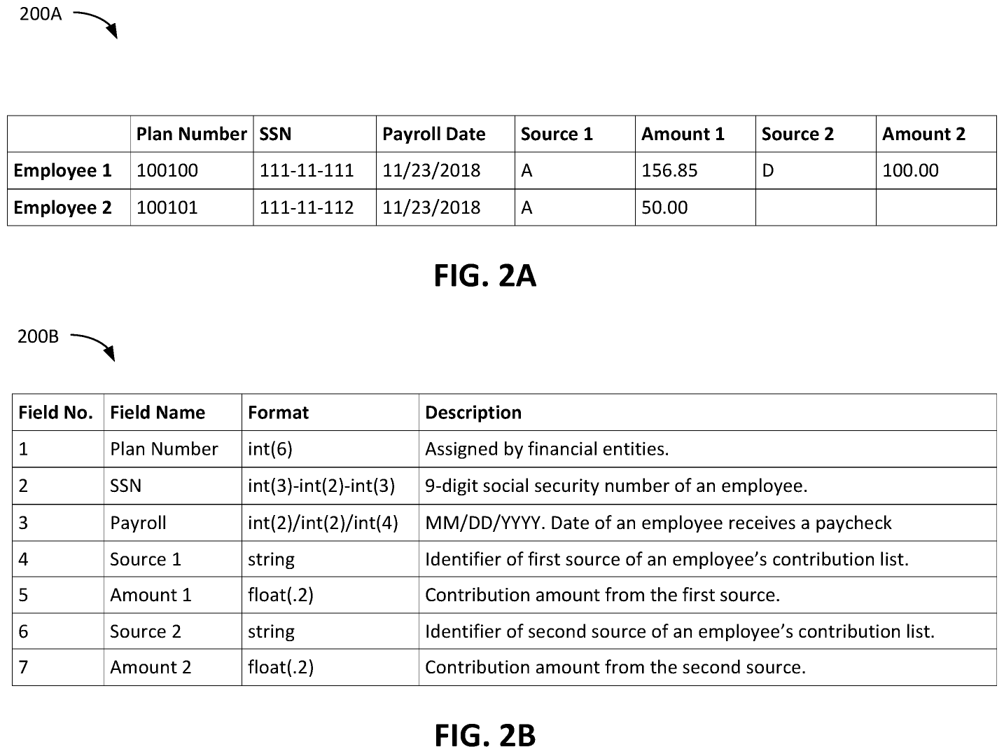

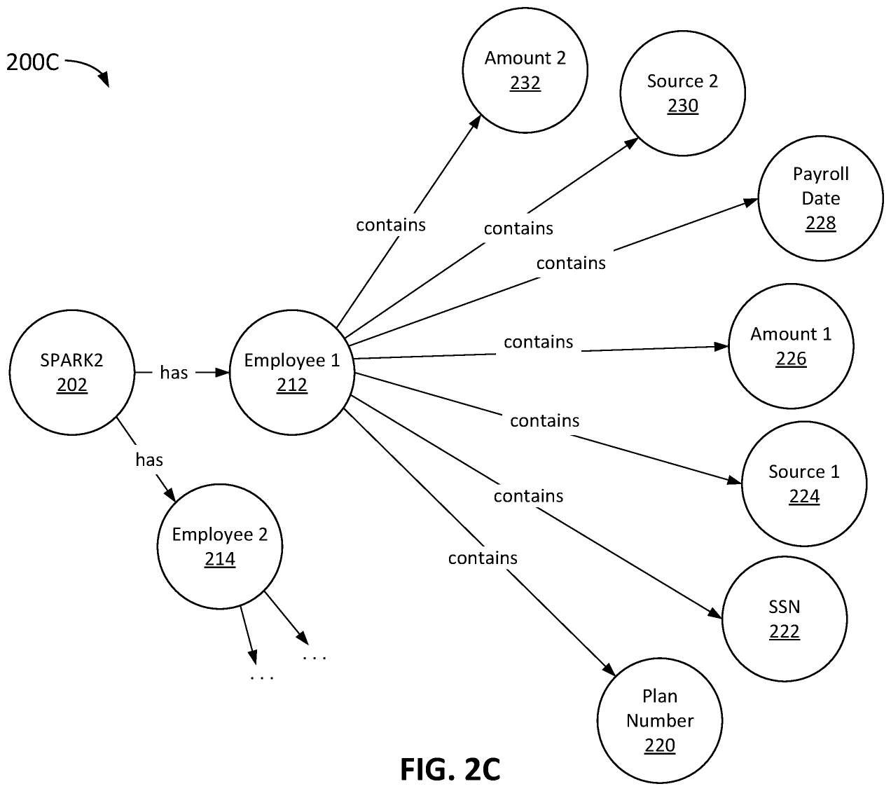

FIG. 2A depicts a content of an example source file 200A. The example source file 200A includes a plurality of data items. In the example depicted in FIG. 2A, the data items are contribution information of employees.

FIG. 2B depicts a content of an example source file specification 200B. The source file specification describes the formats the data items of the example source file 200A. The source file specification also describes meaning of certain data items.

FIG. 2C depicts an example file model 200C generated by the techniques disclosed herein. The depicted example file model 200C is a source file model (i.e., a source-based graph) as it describes a data structure of the example source file 200A. One should understand the file model 200C may be either a source file model or a target file model (i.e., a target-based graph).

As depicted, the example source model 200C may include a root node 202. The root node 202 may indicate a type of the source file 200A. The root node 202 may be linked to a plurality of child nodes, such as the node 212 and the node 214. Each of the nodes 212, 214 may correspond to a respective employee, i.e., employee 1 and employee 2 in the example source file 200A. Each of the nodes 212, 214 may be linked to a plurality of child nodes. More specifically, the node 212 may be linked to child nodes 220-232. Each of the child nodes 220-232 may correspond to data items associated with parent node 212, i.e., employee 1 in the example source file 200A.

The example source model 200C may be generated based on the example source file 200A and the example source file specification 200B. The detail of generating the source model 200C will be described below with respect to FIG. 5.

### Example Transform Map

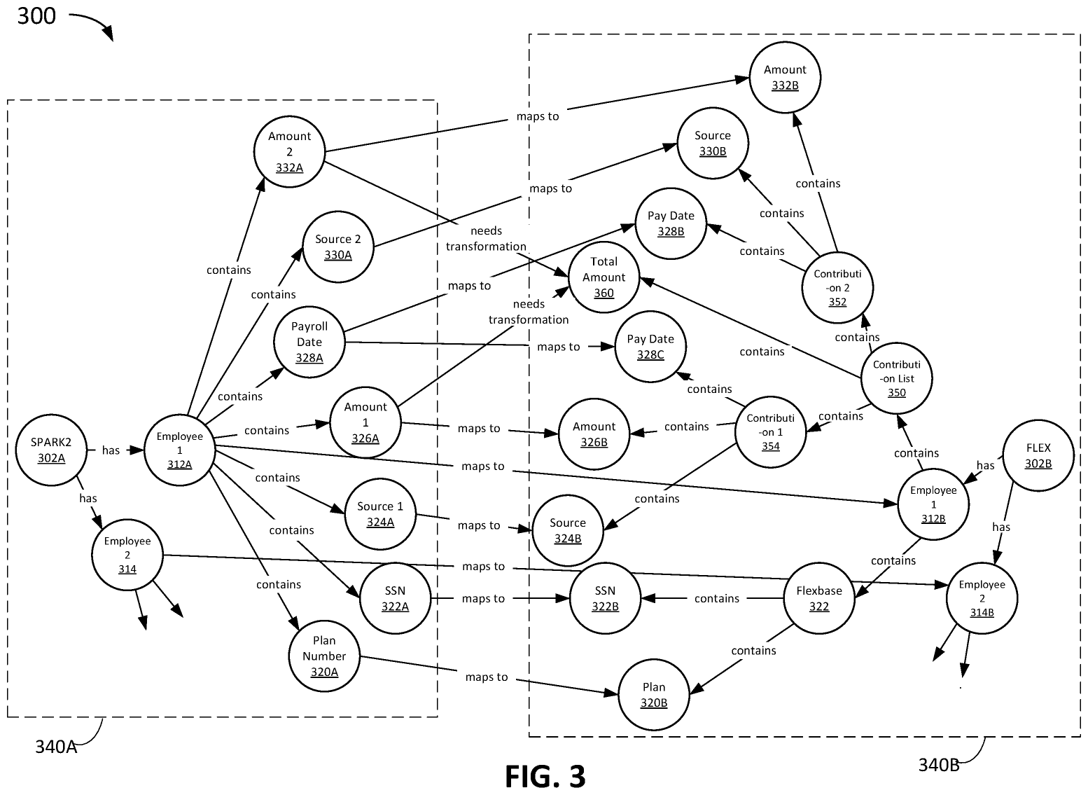

FIG. 3 depicts an example transform map 300 generated by the techniques disclosed herein. The example transform map 300 may describe how certain nodes of an example source file model 340A (such as the example source file model 200C) map to certain nodes of an example target file model 340B.

A node of a source file model 340A may map to one or more nodes of the target file model 340B or in some embodiments does not map to any node. For example, the node 320A of source file model 340A representing a plan number for employee 1 may map to the node 320B representing the same information in the target file model 340B. As another example, the node 328A of the source file model 340A representing a payroll date may map to nodes 328B and 328C representing the same information in the target file model 340B. As yet another example, although not depicted in FIG. 3, some nodes in the source file model 340A may not map to any node of the target file model 340B because, for example, the information represented by the nodes are not needed in the target file model 340B.

In one aspect, a server (such as the implementation computing device 104) may need to perform certain transformations to convert a data item corresponding to a node in the source model 340A to a data item corresponding to a node in the target file model 340B. For example, the nodes 332A and 326A may each represent a contribution amount of a respective contribution source of the employee 1. The node 360 may represent a total contribution amount of all contribution plans of the employee 1. Accordingly, the server may need to sum up the data of nodes 332A and 326A to obtain a data item corresponding to node 360. More detail of file transformation will be described below with respect to FIG. 5.

### Example Transformation Results

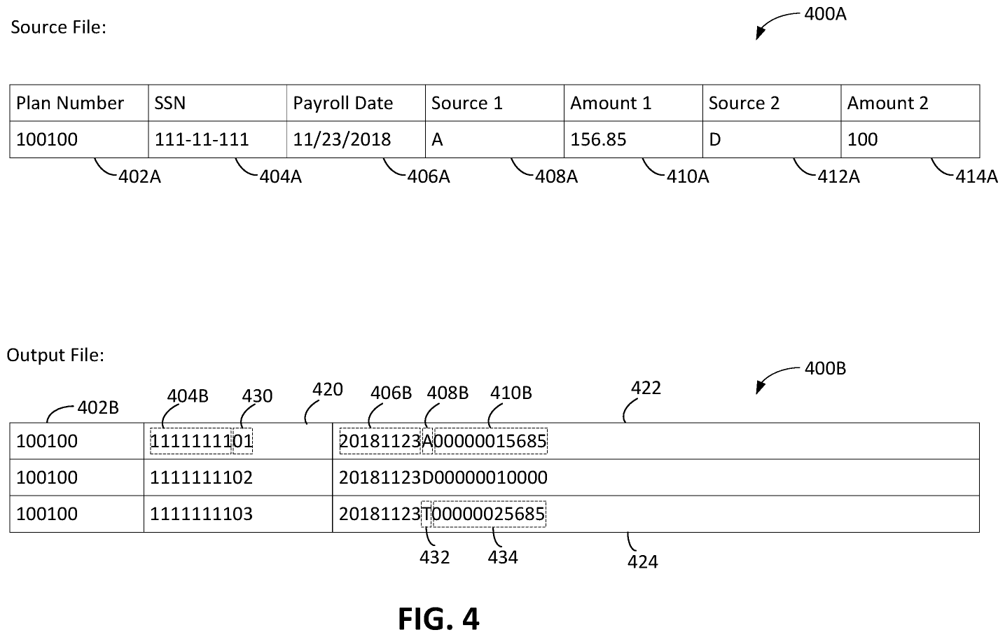

FIG. 4 depicts a content of an example source file 400A and a content of an example output file 400B generated based on the example source file 400A.

A data item in the source file 400A may correspond to a data item, a portion of a data item, multiple data items, or no data items in the output file. For example, the data item 402A in the source file 400A may correspond to the data item 402B in the output file 400B. The data item 404A may correspond to a portion 404B of the data item 420. A portion 430 of the data item 420 may not correspond to any data item of the source file 400A. For example, the portion 430 may be a record identifier. The data items 406A-410A may correspond to portions 406B-410B, respectively. The portion 434 of the data item 424 may be generated based on the data items 410A and 414A, and more specifically, by summing up the data items 410A and 414A. The portion 432 of the data item 424 may not correspond to any data item in the source file 400A. For example, the portion 432 may indicate that the amount is a total amount, instead of for any specific contribution source.

### Example Implementation Process

FIG. 5 depicts a process for implementing the techniques disclosed herein. The process may include (i) a training stage, (ii) a building stage, (iii) a transformation stage, and (iv) a testing stage.

Generally, in the training stage, a training module 504 may use sample data 524 and sample files 526 stored in a training base 502 to train a generative AI. The model and map builder engine 506 may, in the building stage, use the generative AI to generate source models and transform maps for file transformations. The training stage will be described below with respect to FIGS. 6 and 7.

### Building Stage

The building stage may begin at step 530 where a user inputs a source file 512 (such as the example source file 200A) and a source specification 514 (such as the source file specification 200B) into the model and map builder engine 506.

The source file 512 may be a computer or digital file. The source file 512 may include a plurality of data items. The data items may be in various formats and/or represent various kinds of information, such as the data items in the example source file 200A. The source file 512 may correspond to a source file type stored in a training base 502. Example source file types may include SPARK2, FLEX, SOPS, etc.

The source file specification 514 may describe the formats and/or meaning of the data items in the source file 512. In some embodiments, the source file specification 514 may describe the data items in natural language such that a computer engineer or a layman may understand the description. In various implementations, the source file specification 514 may be stored in training base 502.

The model and map builder engine 506 may include a generative AI trained to understand data structure of source files in view of corresponding source file specifications and generate corresponding source models and transform map. At step 534, the model and map builder engine 506 may use the generative AI model to generate a source file model 516 and a transform map 518. The detail of the generative AI model will be described below with respect to FIGS. 6 and 7.

The source file model 516 (such as the example source file model 200C) may be a source-based graph representation of the source file format and the source file specification. More specifically, the source file model 516 describes a data structure of the source file 512. The data structure may include one or more nodes. Some of the one or more nodes may correspond to a respective data item in the source file 512. The model and map builder engine 506 may determine the relationships about the nodes based on the source file 512 and/or the source file specification 514.

The transform map 518 (such as the example transform map 300) may map one or more nodes of the source file model 516 to one or more nodes of a target file model. In some embodiments, a user may input a target file model to the model and map builder engine 506 so that the model and map builder engine 506 may generate the transform map 518 based on the source file model 516 and the target file model. In other embodiments, a user may select a target file type. The model and map builder engine 506 may retrieve a target file model (e.g., from the training base) based on the selected target file type and generate the transform map 518 accordingly. In yet other embodiments, the model and map builder engine 506 use a default target file model to generate the transform map 518 unless a develop instructs otherwise.

After generating the source file model 516 and the transform map 518, the model and map builder engine 506 may invoke a semantic model-based transformation service 507 to generate an output file, as will be described below with respect to the transformation stage. The model and map builder engine 506 may then invoke a comparison model test whether the output file meets certain expectations, as will be described below with respect to the testing stage.

### Transformation Stage

The transformation stage may begin at step 536 where the model and map builder engine 506 inputs the source file model 516 and the transform map 518 into a module for model-based transforming service 507. In some embodiments, the model-based transforming service 507 may intake the source file model 516 and the transform map 518 via an application programming interface (API).

At step 540, The model-based transforming service 507 may apply the transformations in the transform map 518 to data items corresponding to the nodes in the source file model 516.

The transformations may include formal transformations. For example, referring to FIG. 3, the social security number represented by node 324A may be in the format of XXX-XX-XXX, but the target file requires the social security number to be in the format of XXXXXXXX (such as the scenario depicted in FIG. 4). The transform map 518 may include such formal transformation therein. The model-based transforming service 507 may extract the data item corresponding to the node 324A, apply the formal transformation to the data item, and thereby generate a data item corresponding to the node 322B.

The transformations may include logic operations. As described above, the node 360 corresponds to a sum of the amounts of nodes 326A and 332A. The transform map 518 may include such logic operations therein. The model-based transforming service 507 may extract the data items corresponding to the nodes 326A and 332A, respectively, apply the logic operations to the data items, and thereby generate a data item corresponding to the node 360.

After applying all the transformations indicated in the transform map, the model-based transforming service 507 may organize the data items generated by the transformations to generate an output file 520. The output file 520 may be a computer or digital file. In some embodiments, the model-based transforming service 507 may organize the data items based on a target type either indicated by a user or set by default.

In some embodiments, before the model-based transforming service 507 generates the output file 520, a user may input an input sample 528 into the model-based transforming service 507. The input sample 528 may be a template of a target output file or describe the format of a target output file. The model-based transforming service 507 may then generate the output file 520 based on the input sample 528. For example, in various aspects, the input sample can be used as part of training and testing, where the input sample can be defined as a known correct response to be used to validate the model.

### Testing Stage

The testing stage may begin at step 542 where the model-based transforming service 507 inputs the output file 520 into a comparison module 508.

At step 542, a user may input an output sample 522 to the comparison module 508. Additionally or alternatively, at step 542, the comparison module 508 may retrieve an output sample (e.g., from the training base 502) based on a selected target type. The output sample 522 may describe expected formats of the output file 520.

At step 546, the comparison module 508 may test the output file 520 by comparing the output file 520 to the output sample 522. In some embodiments, the comparison module 508 may include an AI model trained to determine whether output files match descriptions of corresponding output samples. The comparison module 508 may use the AI model to make such determinations. The detail of the AI model will be described below with respect to FIGS. 6 and 7.

If the comparison module 508 determines that the output file 520 matches the output sample 522, the comparison module 508 may determine that the output file 520 passes the test. Further, at step 548, the comparison module 508 may register the source file model 516 and the transform map 518 with the training base 502. In this way, the training module 504 may update the model and map builder engine 506 using the source file model 516 and the transform map 518, which will be described below in detail in the continuously learning section.

Otherwise, the comparison module 508 determines that the output file 520 does not match the output sample 522, the comparison module 508 may cause the server to present an indication of the mismatch. A user may look into the situation and make appropriate adjustments. For example, a user may adjust the model-based transforming service 507, or a related model thereof, as necessary to output an accurate result (e.g., a new output file 520). After the adjustments, the user may restart the process from step 530 to step 546.

### Example AI Model

As indicated above, the server (such as the implementation computing device 104) may user AI models to generate source file models and transform maps, and to determine whether output files match respective output samples.

FIG. 6 depicts a structure of a neural network AI model 600, as an example of the AI model disclosed herein. It should be understood, however, that by including position embeddings into input dataset and configure the neurons in a certain manner, the neural network AI model 600 may be a transformer model. After appropriate training, the neural network AI model 600 may be a generative pretrained transformer (GPT) model. One will appreciate other appropriate models may be used, including but not limited to Naïve Bayes, Linear Regression, Logistic Regression, Support Vector Machine, etc.

The example AI model 600 having an input layer 602, one or more intermediate layers 604, 606, and an output layer 608. Each of the layers in the example AI model 600 may include an arbitrary number of neurons x₁-y₂. The plurality of layers may chain neurons together linearly and may pass output from one neuron to the next, or may be networked together such that the neurons communicate input and output in a non-linear way. For example, each of the neurons h₁-h₄ may be a weighted sum of x₁-x₃, i.e.,

$${h}_{j} = {\sum }_{i = 1}^{n} {u}_{ij} {x}_{1} , j = 1 , 2 , … , m$$

where for the example AI model 600, n=3, and m=4.

In general, it should be understood that various configurations and/or connections of the example AI model 600 are possible. In an embodiment, the input layer may correspond to vectorized input. For example, if the example AI model 600 is the generative AI for generating source file models and transform maps, when the model and map builder engine 506 uses the AI model to generate the source file model 516 or the transform map 518, the engine 506 may convert the content of a source file 512 and a source file specification 514 to a set of vectors, such as (x₁, . . . , xₙ). As another example, if the example AI model 600 is the AI for determining whether output files matches respective output samples, when comparison module 508 uses the AI model, the engine 506 may convert the content of the output file 520 and the output sample 522 to a set of vectors, such as (x₁, . . . , xₙ). Each of the values of the vectors, i.e., x₁, . . . , xₙ, may be an input corresponding to a respective neuron in the input layer 602.

The input layer 602 may correspond to a large number of input values (e.g., one million inputs), in some embodiments, and may be analyzed serially or in parallel. Further, various neurons and/or neuron connections within the example AI model 600 may be initialized with any number of weights (such as the weights uᵢⱼ, tᵢⱼ, and wᵢⱼ). Each of the neurons in the intermediate layers 604, 606 may analyze one or more of the input parameters from the input layer, and/or one or more outputs from a previous one or more of the intermediate layers, to generate an output.

The output layer 608 may include one or more outputs, each indicating a respective result. For example, if the example AI model 600 is the generative AI model for generating file models and transform maps, the output may be one or more set of vectors (y₁, . . . , yₙ). The server may then convert the set of vectors based on certain rules to generate a file model or a transform map. As another example, if the example AI model 600 is the AI model for determining whether an output file matches an output sample, the data is complete, the output neuron y₁ may be a numerical value indicating whether there is a match, such as y₁=1 indicates a match, and y₁=0 indicates a mismatch. The output neuron y₂-yₙ may be one or more vectors indicating the reason for the match or mismatch. The server may convert the vector to its corresponding words or phrase, such that a user may under the output.

### Example Training Process

Referring back FIG. 5, the training process may begin at step 550, where a user may input sample data 524 and sample files 526 into the training base 502. The sample data 524 may include a plurality of sample source data sets, a plurality of sample output data sets associated with respective sample source data sets. The sample data 524 may be in various formats, including marks and other formats parsed from the sample files 526. The sample files 526 may include sample source data specifications associated with respective sample source data sets, and output samples associated with sample output files. The training base 502 may further include sample source file models associated with respective sample source data sets and sample source specifications, and sample transform maps associated with respective sample source file model and sample target file model. In some embodiments, the training base 502 may further include target file model associated with respective target file types.

To train the generative AI model for generating source file models, at step 554, a training module 504 (such as the training module 170) may retrieve training data from the training base 502, including the sample data 524, the sample files 526, sample file models, and sample transform maps from the. At step 556, the training module 504 may train the generative AI using the training data, as will be discussed below with respect to FIG. 7.

To train the AI model for determining whether output files match respective output samples, at step 554, the training module 508 may retrieve training data from the training base 502, including sample output files and output samples. At step 558, the training module 504 may train the AI using the training data, as will be discussed below with respect to FIG. 7.

FIG. 7 depicts a process for training the example AI model 600 of FIG. 6. One will appreciate other appropriate training techniques may be used. Some of the blocks in FIG. 7 may represent hardware and/or software components, other blocks may represent data structures or memory storing these data structures, registers, or state variables (e.g., 712), and other blocks may represent output data (e.g., 725). Input and/or output signals may be represented by arrows labeled with corresponding signal names and/or other identifiers.

The system and methods to generate and/or train an AI model (e.g., via the training module 170 of the training computing device 106), may consists of three steps: (1) a supervised training step, at which stage the AI model may represent a cursory model for what may be later developed and/or configured as the AI model; (2) a reward model step where human labelers may rank numerous AI model outputs to evaluate the output which best mimic preferred human output, generating comparison data, and be trained with on the comparison data; and/or (3) a policy optimization step in which the reward model may further improve the AI model. In one aspect, step one may take place only once, while steps two and three may be iterated continuously, e.g., more comparison data is collected on the current AI model, which may be used to optimize/update the reward model and/or further optimize/update the policy.

In some embodiments, an AI model may be pretrained before it undergoes the training stages (1)-(3) above. For example, the generative AI model for generating file models and transform maps may be pretrained to “understand” the sample data and files. More specifically, in the pretraining stage, the generative AI model may be required to predict a masked portion of a sentence (such as a sentence in a sample file specification), and adjust its parameters based on the difference between its predictions and the portion of the sentence that was under mask in a similar manner as described below with respect to the supervised training stage. As another example, to pretrain the AI model for determining whether output files match respective output samples, the AI model may be required to predict a masked portion of a sentence (such as a sentence in an output sample), and adjust its parameters in a similar manner.

### Supervised Training

In a first training stage 702, the training module 504 may train an AI model using supervised learning techniques. This training stage is described below with reference to both FIGS. 6 and 7.

Using the example AI model 600 in FIG. 6 as an example, the weights uᵢⱼ, tᵢⱼ, and wᵢⱼ are parameters of the model. One will appreciate that the AI model may include other parameters. For example, if zᵢ is calculated using hᵢ based on the weights tᵢⱼ and other parameters, such other parameters are also parameters of the example AI model 600.

When the training module 504 trains the example AI model 600, the training module 502 updates the weights uᵢⱼ, tᵢⱼ, wᵢⱼ and optionally other parameters iteratively. For example, to training the generative AI for generating file models, the training module 502 may feed the example AI model 600 (corresponding to the model 710 in FIG. 7) with a plurality of sample source files, a plurality of sample source file specifications associated with respective sample source files, and a plurality of sample source file models associated with the respective sample source files and sample source file specifications, which is the training dataset 712 in FIG. 7. The example AI model 600 may receive the plurality of sample source files and the plurality of sample source file specifications at the input layer 602. The example AI model 600 may generate a set of output y₁ and y₂ using a set of randomly (or otherwise) initialized parameters uᵢⱼ, tᵢⱼ, and wᵢⱼ. The example AI model 600 may compute a change to the parameters uᵢⱼ, tᵢⱼ, and wᵢⱼ based on differences between the output y₁ and y₂ and the plurality of sample source file models. The change may be proportional to the differences. For example, when the differences are greater, the changes to the parameters uᵢⱼ, tᵢⱼ, and wᵢⱼ are greater.

Upon the parameters uᵢⱼ, tᵢⱼ, and wᵢⱼ converge to a certain range, that is, the changes to the parameters are smaller than a predetermined threshold, the AI model 600 may be determined to be ready for use or for further training as described below (corresponding to the model 715 in FIG. 7).

The training module 504 may train the generative AI model for generating transform maps (which may be the same AI model for generating source file models but perform different functionalities based on different prompts or inputs) and the AI model determine whether output files match output samples in a similar manner.

More specifically, to train the generative AI model for generating transform maps, the training module 504 may feed the example AI model 600 a plurality of sample source file models and a plurality sample target files models associated with respective sample source file models at the input layer 602. The training module 504 may compare the transform maps generated at the output layer 608 and sample transform maps associated with respective source file models and target file models. The training module 504 may then update the parameters of the example AI model 600 based on the differences from the comparison.

To train the AI model for determining whether output files match output samples, the training module 504 may feed the example AI model 600 a plurality of sample output files and a plurality of output samples associated with respective sample output files at the input layer 602. The training module 504 may compare the comparison results generated at the output layer 608 and sample comparison results associated with respective sample output files and output samples. The training module 504 may then update the parameters of the example AI model 600 based on the differences from the comparison.

### Training Reward Model

In a second training stage 704, the training module 502 may train a reward model using human feedback. The training module 502 may a reward model 720 to provide as an output a scaler value/reward 725. The reward model 720 may be required to leverage Reinforcement Learning with Human Feedback (RLHF) in which a model (e.g., AI model 750) learns to produce outputs which maximize its reward 725, and in doing so may provide output which are better aligned to inputs.

Training the reward model 720 may include the training module 502 providing an input for training 722. This input may be different from the training dataset described above. For example, to train the generative AI model for generating source file models, the input for training may include sample source files and sample source specifications, but not include the corresponding sample source file models. To train the generative AI model for generating transform maps, the input for training may include sample source file models and sample target file models, but not include the corresponding sample transform map. To train the AI model for determining matches between output files and output samples, the input for training may include sample output files and output samples, but not include the corresponding comparison results. Additionally, the training dataset used in the second stage 704 may be the data not seen by the AI model when it is trained in the first stage 702.

Based on the input for training 722, the AI model 715 may generate various outputs 724A, 724B, 724C, and 724D. The training module 502 may present the output 724A, 724B, 724C, and 724D to a user interface device, such as a display (e.g., as text or graphical output), a speaker (e.g., as audio/voice output), and/or any other suitable manner of output of the output 724A, 724B, 724C, and 724D for review by the data labelers.

The data labelers may provide feedback via the training module 502 on the output 724A, 724B, 724C, and 724D when ranking 726 them from best to worst based on the input-output pairs. The data labelers may rank 726 the output 724A, 724B, 724C, and 724D by labeling the associated data. The ranked input-output pairs 728 may be used to train the reward model 720. The reward model 720 may provide as an output the scalar reward 725.

The scalar reward 725 may include a value numerically representing a human preference for the best and/or most expected output to an input. For example, inputting the “winning” input-output pair data to the reward model 720 may generate a winning reward. Inputting a “losing” input-output pair data to the same reward model 720 may generate a losing reward. The reward model 720 and/or scalar reward 725 may be updated based up labelers ranking 726 additional input-output pairs generated in output to additional inputs for training 722.

### RLHF Training

In a third training stage 706, the training module 502 may optimize the AI model using the reward model trained in the second stage.

The training module 502 may train the AI model 750 to generate an output 734 to a random, new and/or previously unknown input 732. To generate the output 734, the AI model 750 may use a policy 735 which it learns during training of the reward model 220, and in doing so may advance from the AI model 715 to the AI model 750. The policy 735 may represent a strategy that the AI model 750 learns to maximize the reward 725. Reflected in the inner structure of the AI model, the policy is implemented as a set of parameter values (e.g., the weights uᵢⱼ, tᵢⱼ, and wᵢⱼ) that allow the AI model to maximize the reward 725. As discussed herein, based upon input-output pairs, a human labeler may continuously provide feedback to assist in determining how well the output of AI model 750 matches expected output to determine the rewards 725. The rewards 725 may feed back into the AI model 750 to evolve the policy 735, i.e., updating the parameters of the AI model. The training module 502 may update the policy 735 as the AI model 750 provides output 734 to additional inputs 732.

In one aspect, the output 734 of the AI model 750 using the policy 735 based upon the reward 725 may be compared using a cost function 738 to the AI model 715 (which may not use a policy) output 736 of the same input 732. The cost function 738 may be trained in a similar manner and/or contemporaneous with the reward model 720. The training module 502 may compute a cost 740 based upon the cost function 738 of the output 734, 736. The cost 740 may reduce the distance between the output 734, 736, i.e., a statistical distance measuring how one probability distribution is different from a second, in one aspect the output 734 of the AI model 750 versus the output 736 of the model 715. Using the cost 740 to reduce the distance between the output 734, 736 may avoid a training module 502 over-optimizing the reward model 720 and deviating too drastically from the human-intended/preferred output. Without the cost 740, the AI model 750 optimizations may result in generating output 734 which are unreasonable but may still result in the reward model 720 outputting a high reward 725.

The output 734 of the AI model 750 using the current policy 735 may be passed by the training module 502 to the reward model 720, which may return the scalar reward 725. The AI model 750 output 734 may be compared via the cost function 738 to the AI model 715 output 736 by the training module 502 to compute the cost 740. The training module 502 may generate a final reward 742 which may include the scalar reward 725 offset and/or restricted by the cost 740. The final reward 742 may be provided by the training module 502 to the AI model 750 and may update the policy 735, which in turn may improve the functionality of the AI model 750.

### Continuous Learning

In some embodiments, the training module 502 may use data from successful instances to continuously train the AI models described above. Referring back to FIG. 5, as indicated above, if the comparison module 508 determines that the output file 520 matches the output sample 522, at step 548, the comparison module 508 may register the source file model 516 and the transform map 518 with the training base 502. The training module 504 may then use the source file model 516 and the transform map 518 to continuously train the generative AI model used in the techniques disclosed herein.

To implement the continuous learning, the training module 502 may use the new training data (i.e., the source file model 516 and the transform map 518) to further training the AI models for one more iteration. Alternatively, the training module 502 may, after receiving a considerable amount of new input for training, retrain the AI model using the entire training dataset including the new inputs. In some embodiments, the training module 502 may remove old training data periodically to make sure the training data meets users' up-to-date needs. The new training data may be used to train the AI models in any of the training stages 702-706 described above.

In this way, as the model and map builder engine 506 successfully generates source file models and transform maps that pass the test of the comparison module 508, the training module 502 receives more successful source file models and transform maps and use them to continuously update the AI models. The AI models are thus improved continuously and may meet users' changing needs.

### Overall Process

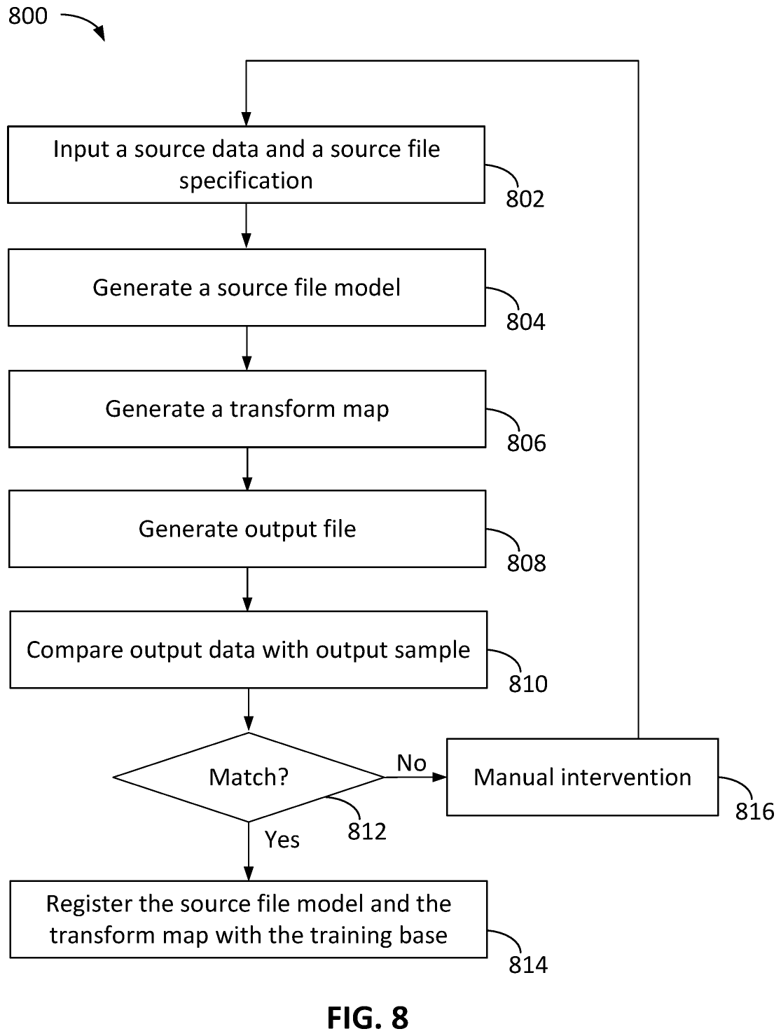

FIG. 8 depicts an example sequence diagram that illustrates a method for file transformations using AI-based models, according to some embodiments.

At block 802, an implementation server (such as the implementation computing device 104) may input a source file and a source file specification, corresponding to a source file type selected from the training base, the source file including one or more source data items, the source file specification defining formats of the one or more source data items, as discussed with respect to step 530.

At block 804, the implementation server may generate, using a generative AI model based on the source data and the source file specification, a source file model comprising a source-based graph representation including one or more source nodes, each of one or more source nodes associated with a respective data item of the one or more source data items, as discussed with respect to step 534.

At block 806, the implementation server may generate, using the generative AI model, a transform map mapping the one or more source nodes to one more target nodes of a target-based graph of a target file model corresponding to a target file type, as discussed with respect to step 534. In some embodiments, the implementation server may receive a user input indicating the target file type, and retrieve, from the training base, the target file model corresponding to the target file type, the target file model comprising the target-based graph, as discussed with respect to step 530.

At block 808, the implementation server may invoke a semantic model-based transformation service to generate an output file by applying the transform map to the one or more nodes of the source file model, as discussed with respect to steps 536-540. In some embodiments, to generate the output file, the implementation server may apply the plurality of transformations to the one or more source data items associated with respective nodes of the source file model to generate a plurality of output data items and organize the plurality of output data items to generate the output file, as discussed with respect to step 540.

At block 810, the implementation server may invoke a comparison module to compare the output file to output sample, the output sample describing expected formats of the output file, as discussed with respect to step 546. In some embodiments, the implementation server may use an AI model for comparison to perform the comparison, as discussed with respect to step 546.

At block 812, the implementation server may determine whether the output file matches the output sample based on the comparison, as discussed with respect to step 546.

If the implementation server determines that the output file matches the output sample, at block 814, the implementation server may update the training base by registering the source file model and the transform map with the training base, as discussed with respect to steps 548. In some embodiments, the implementation server may update the generative AI model using the source file model and the transform map, as discussed in the continuous learning section.

If the implementation server determines that the output file does not match the output sample, at block 816, a user may perform certain manual interventions, as discussed with respect to steps 546.

In some embodiments, a training server (such as the training computing device 106) may train the generative AI, including inputting a plurality of sample source files and a plurality of sample source file specifications associated with respective sample source files into the generative AI model to generate a plurality of source file models, determining differences between the plurality of source file models with a plurality sample source file models associated with respective sample source files and sample source file specifications, and iteratively updating the plurality of parameters based on the differences, as discussed with respect to FIGS. 6 and 7.

It should be understood that not all blocks in FIG. 8 need to be implemented. Additional and alternative blocks may be implemented. The blocks FIG. 8 do not have to be implemented in the particular order as depicted.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one embodiment” or “an embodiment” means that a particular element, feature, structure, or characteristic described in connection with the embodiment is included in at least one embodiment or embodiment. The appearances of the phrase “in one embodiment” in various places in the specification are not necessarily all referring to the same embodiment.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for generating private metaverse through the principles described herein. Thus, while particular embodiments and applications have been illustrated and described, it is to be understood that the disclosed embodiments are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. An artificial intelligence (AI) based model builder system configured to automatically transform computer files, the system comprising:
one or more processors; and
a training base comprising a memory configured to store data formats, sample data, and data specifications defining one or more respective file types;
a generative AI model;
a model and map builder engine comprising computing instructions configured to access the AI model and the training base,
wherein the computing instructions of the model and map builder engine, when executed by the one or more processors, cause the one or more processors to:
input a source file and a source file specification, corresponding to a source file type selected from the training base, the source file including one or more source data items, the source file specification defining formats of the one or more source data items;
generate, using the generative AI model based on the source file and the source file specification, a source file model comprising a source-based graph representation including one or more source nodes, each of one or more source nodes associated with a respective data item of the one or more source data items;
generate, using the generative AI model, a transform map mapping the one or more source nodes to one more target nodes of a target-based graph of a target file model corresponding to a target file type;
invoke a semantic model-based transformation service to generate an output file by applying the transform map to the one or more nodes of the source file model; and
invoke a comparison module to compare the output file to an output sample, the output sample describing expected formats of the output file.

2. The system of claim 1, wherein the computing instructions, when executed by the one or more processors, cause the one or more processors to:
determine, based on the comparison, that the output file matches the output sample; and
update the training base by registering the source file model and the transform map with the training base.

3. The system of claim 2, wherein the computing instructions, when executed by the one or more processors, cause the one or more processors to:
update the generative AI model using the source file model and the transform map.

4. The system of claim 1, wherein to generate the transform map, the computing instructions, when executed by the one or more processors, cause the one or more processors to:
receive a user input indicating the target file type; and
retrieve, from the training base, the target file model corresponding to the target file type, the target file model comprising the target-based graph.

5. The system of claim 1, wherein the generative AI model includes a plurality of parameters, and to train the generative AI model, the computing instructions, when executed by the one or more processors, cause the one or more processors to:
input a plurality of sample source files and a plurality of sample source file specifications associated with the sample source files into the generative AI model to generate a plurality of source file models;
determine differences between the plurality of source file models and a plurality sample source file models associated with the sample source files and sample source file specifications; and
iteratively update the plurality of parameters based on the differences.

6. The system of claim 1, wherein the system further comprises an AI model for comparison, and wherein to invoke the comparison module to compare the output file to the output sample, the computing instructions, when executed by the one or more processors, cause the one or more processors to:
invoke the comparison module to use the AI model for comparison to compare the output file to the output sample.

7. The system of claim 1, wherein the transform map includes one or more transformations associated with the one or more source nodes and the one or more target nodes, and wherein to invoke the semantic model-based transformation service to generate the output file, the computing instructions, when executed by the one or more processors, cause the one or more processors to:
apply the one or more transformations to the one or more source data items associated with the one or more source nodes to generate one or more output data items; and
organize the one or more output data items to generate the output file.

8. An artificial intelligence (AI) based model builder method for automatically transform computer files, comprising:
inputting, by one or more processors, a source file and a source file specification, corresponding to a source file type selected from a training base, the source file including one or more source data items, the source file specification defining formats of the one or more source data items;
generating, by the one or more processors using a generative AI model based on the source data and the source file specification, a source file model comprising a source-based graph representation including one or more source nodes, each of one or more source nodes associated with a respective data item of the one or more source data items;
generating, by the one or more processors using the generative AI model, a transform map mapping the one or more source nodes to one more target nodes of a target-based graph of a target file model corresponding to a target file type;
invoking, by the one or more processors, a semantic model-based transformation service to generate an output file by applying the transform map to the one or more nodes of the source file model; and
invoking, by the one or more processors, a comparison module to compare the output file to an output sample, the output sample describing expected formats of the output file.

9. The computer-implemented method of claim 8, comprising:
determining, by the one or more processors based on the comparison, that the output file matches the output sample; and
updating, by the one or more processors, the training base by registering the source file model and the transform map with the training base.

10. The computer-implemented method of claim 9, comprising:
updating, by the one or more processors, the generative AI model using the source file model and the transform map.

11. The computer-implemented method of claim 8, wherein generating the transform map comprises:
receiving, by the one or more processors, a user input indicating the target file type; and
retrieving, by the one or more processors from the training base, the target file model corresponding to the target file type, the target file model comprising the target-based graph.

12. The computer-implemented method of claim 8, wherein the generative AI model includes a plurality of parameters, and training the generative AI model comprises:
inputting, by the one or more processors, a plurality of sample source files and a plurality of sample source file specifications associated with the sample source files into the generative AI model to generate a plurality of source file models;
determining, by the one or more processors, differences between the plurality of source file models and a plurality sample source file models associated with the sample source files and sample source file specifications; and
iteratively updating, by the one or more processors, the plurality of parameters based on the differences.

13. The computer-implemented method of claim 8, wherein invoking the comparison module to compare the output file to the output sample includes using an AI model for comparison to compare the output file to the output sample.

14. The computer-implemented method of claim 8, wherein the transform map includes one or more transformations associated with the one or more source nodes and the one or more target nodes, and wherein to invoke the semantic model-based transformation service to generate the output file, and wherein invoking the semantic model-based transformation service to generate the output file comprises:
apply, by the one or more processors, the transformations to the one or more source data items associated with the one or more source nodes to generate one or more output data items; and
organize, by the one or more processors, the one or more output data items to generate the output file.

15. A computer readable storage medium storing computing instructions for automatically transforming computer files with artificial intelligence (AI), the computing instructions that, when executed by one or more processors, cause the one or more processors to:
input a source file and a source file specification, corresponding to a source file type selected from a training base, the source file including one or more source data items, the source file specification defining formats of the one or more source data items;
generate, using a generative AI model based on the source data and the source file specification, a source file model comprising a source-based graph representation including one or more source nodes, each of one or more source nodes associated with a respective data item of the one or more source data items;
generate, using the generative AI model, a transform map mapping the one or more source nodes to one more target nodes of a target-based graph of a target file model corresponding to a target file type;
invoke a semantic model-based transformation service to generate an output file by applying the transform map to the one or more nodes of the source file model; and
invoke a comparison module to compare the output file to an output sample, the output sample describing expected formats of the output file.

16. The computer readable storage medium of claim 15, wherein the computing instructions that, when executed by one or more processors, cause the one or more processors to:
determine, based on the comparison, that the output file matches the output sample; and
update the training base by registering the source file model and the transform map with the training base.

17. The computer readable storage medium of claim 16, wherein the computing instructions that, when executed by one or more processors, cause the one or more processors to:
update the generative AI model using the source file model and the transform map.

18. The computer readable storage medium of claim 15, wherein to generate the transform map, the computing instructions, when executed by the one or more processors, cause the one or more processors to:
receive a user input indicating the target file type; and
retrieve, from the training base, the target file model corresponding to the target file type, the target file model comprising the target-based graph.

19. The computer readable storage medium of claim 15, wherein the generative AI model includes a plurality of parameters, and to train the generative AI model, the computing instructions, when executed by the one or more processors, cause the one or more processors to:
input a plurality of sample source files and a plurality of sample source file specifications associated with the sample source files into the generative AI model to generate a plurality of source file models;
determine differences between the plurality of source file models and a plurality sample source file models associated with the sample source files and sample source file specifications; and
iteratively update the plurality of parameters based on the differences.

20. The computer readable storage medium of claim 15, wherein to invoke the comparison module to compare the output file to the output sample, the computing instructions, when executed by the one or more processors, cause the one or more processors to:
invoke the comparison module to use an AI model for comparison to compare the output file to the output sample.
